(19) United States
(12) Patent Application Publication
(10) Pub. No.: US 2014/0259903 A1
(43) Pub. Date: Sep. 18, 2014

(54) WATER LEVEL INDICATING TREE STAND

(71) Applicant: Scott James Earliwine, West Mifflin, PA (US)

(72) Inventor: Scott James Earliwine, West Mifflin, PA (US)

(21) Appl. No.: 14/205,437

(22) Filed: Mar. 12, 2014

Related U.S. Application Data
(60) Provisional application No. 61/786,493, filed on Mar. 15, 2013.

(51) Int. Cl. G08B 21/18; A47G 33/12

(52) U.S. Cl. CPC G08B 21/182; A47G 33/12
USPC 47/40.5; 340/618

(57) ABSTRACT

A tree stand is described that secures a tree while monitoring and replenishing a water supply for sustaining the tree. The tree stand includes a tree stand base having a reservoir configured to receive a trunk of a tree and contain water for nourishing the tree, and a water supply monitoring system configured to asses a level of the water in the reservoir. The water supply monitoring system includes a funnel insertable within the reservoir for supplying water to the reservoir, a water level monitoring system physically coupled to the tree stand base that is configured to assess a first water level indicative of a low water level in the reservoir and assess a second water level indicative of an optimal water level in the reservoir, an indicating system electrically coupled to the water level monitoring system that provides a water level indication, and a power system coupled to the water level monitoring system and the indicating system.

### CROSS-REFERENCE TO RELATED APPLICATIONS

Pursuant to 37 C.F.R. §1.78(a)(4), this application claims the benefit of and priority to co-pending U.S. Provisional Application No. 61/786,493, filed on Mar. 15, 2013, which is expressly incorporated by reference herein in its entirety.

### FIELD OF INVENTION

The invention relates to a tree stand for securing a tree, and in particular, a tree stand having a water monitoring system for indicating a water level in the tree stand.

### BACKGROUND OF THE INVENTION

### Description of Related Art

As is well known to those who decorate their home with a fresh cut tree to celebrate Christmas, a tree stand is used to secure the tree upright, and provide a reservoir for providing water to sustain the freshness of the tree at least temporarily. When the water level is not maintained at an adequate level, the tree prematurely dries out. Constant monitoring of the water level through observation by the user is inconvenient, and when the water level requires replenishment, access to the reservoir is limited. Consequently, what is needed is an improved system for monitoring the water level in the tree stand, and providing access for adding water to the reservoir.

### SUMMARY OF THE INVENTION

Embodiments of the invention relate to a tree stand for securing a tree, and in particular, a tree stand having a water monitoring system for indicating a water level in the tree stand.

According to one embodiment, a tree stand is described that secures a tree while monitoring and replenishing a water supply for sustaining the tree. The tree stand includes a tree stand base having a reservoir configured to receive a trunk of a tree and contain water for nourishing the tree, and a water supply monitoring system configured to asses a level of the water in the reservoir. The water supply monitoring system includes a funnel insertable within the reservoir for supplying water to the reservoir, a water level monitoring system physically coupled to the tree stand base that is configured to assess a first water level indicative of a low water level in the reservoir and assess a second water level indicative of an optimal water level in the reservoir, an indicating system electrically coupled to the water level monitoring system that provides a water level indication, and a power system coupled to the water level monitoring system and the indicating system.

According to another embodiment, a tree stand is described. The tree stand includes: a tree stand base having a reservoir configured to receive a trunk of a tree and contain water for nourishing the tree, the tree stand base further including means for securing the trunk of the tree within the reservoir; and a water supply monitoring system configured to assess a level of the water in the reservoir. The water supply monitoring system includes: a funnel insertable within the reservoir, the funnel having a tubular section configured to extend into the reservoir and supply water through an outlet end, and a funnel section located at an inlet end to the tubular section for supplying water to the reservoir through the tubular section; a water level monitoring system physically coupled to the tree stand base that is configured to assess a first water level indicative of a low water level in the reservoir and assess a second water level indicative of an optimal water level in the reservoir; an indicating system electrically coupled to the water level monitoring system that is configured to provide a first indicator when the first water level is achieved and a second indicator when the second water level is achieved; and a power system coupled to the water level monitoring system and the indicating system, and configured to provide power to the water level monitoring system and the indicating system.

According to yet another embodiment, a monitoring system for a tree stand is described. The monitoring system includes a water supply monitoring system configured to be coupled to a tree stand base having a reservoir that receives a trunk of a tree and contains water for nourishing the tree, wherein the water supply monitoring system is further configured to asses a level of the water in the reservoir. The water supply monitoring system includes: a funnel insertable within the reservoir, the funnel having a tubular section configured to extend into the reservoir and supply water through an outlet end, and a funnel section located at an inlet end to the tubular section for supplying water to the reservoir through the tubular section; a water level monitoring system physically coupled to the tree stand base that is configured to assess a first water level indicative of a low water level in the reservoir and assess a second water level indicative of an optimal water level in the reservoir; an indicating system electrically coupled to the water level monitoring system that is configured to provide a first indicator when the first water level is achieved and a second indicator when the second water level is achieved; and a power system coupled to the water level monitoring system and the indicating system, and configured to provide power to the water level monitoring system and the indicating system.

### BRIEF DESCRIPTION OF THE DRAWINGS

In the accompanying drawings:

FIG. 1 depicts a tree stand according to an embodiment;

FIG. 2 shows a portion of a tree stand in cross-section with a water level monitoring system physically coupled to the tree stand according to another embodiment; and

FIG. 3 shows a funnel having an indicating system mounted thereon according to yet another embodiment.

### DETAILED DESCRIPTION OF SEVERAL EMBODIMENTS

An apparatus for securing a tree, such as a Christmas tree, is described in various embodiments. One skilled in the relevant art will recognize that the various embodiments may be practiced without one or more of the specific details, or with other replacement and/or additional methods, materials, or components. In other instances, well-known structures, materials, or operations are not shown or described in detail to avoid obscuring aspects of various embodiments of the invention. Similarly, for purposes of explanation, specific numbers, materials, and configurations are set forth in order to provide a thorough understanding of the invention. Nevertheless, the invention may be practiced without specific details. Furthermore, it is understood that the various embodiments shown in the figures are illustrative representations and are not necessarily drawn to scale.

Reference throughout this specification to “one embodiment” or “an embodiment” means that a particular feature, structure, material, or characteristic described in connection with the embodiment is included in at least one embodiment of the invention, but do not denote that they are present in every embodiment. Thus, the appearances of the phrases “in one embodiment” or “in an embodiment” in various places throughout this specification are not necessarily referring to the same embodiment of the invention. Furthermore, the particular features, structures, materials, or characteristics may be combined in any suitable manner in one or more embodiments. Various additional layers and/or structures may be included and/or described features may be omitted in other embodiments.

As briefly described above, an improved system for monitoring the water level in a tree stand is needed. According to various embodiments, a tree stand, which may be useful for securing and holding upright live Christmas trees, is described. The tree stand includes a water monitoring system and an indicating system for alerting a consumer when their tree is in need of water. This system eliminates, among other things, the need for the consumer to bend and crawl underneath their tree and feel around with their fingers to gage the water level.

Therefore, FIG. 1 depicts a tree stand 100 according to an embodiment. The tree stand 100 includes a tree stand base 110 having a reservoir 112 configured to receive a trunk of a tree 115 and contain water for nourishing the tree, the tree stand base 110 further including means for securing 120 the trunk of the tree 115 within the reservoir 112. The tree stand 100 further includes a water supply monitoring system 130 configured to assess a level 155 of the water in the reservoir 112. FIG. 2 shows a portion of tree stand 100 in cross-section with the water level monitoring system 130 physically coupled to the tree stand base 110. As an example, the tree stand base 110 can include an HMS ULTIMATE CHRISTMAS TREE STAND FOR 8′ TREES, commercially available from Sears (Item # SPM3438721101, Model #009312561940).

Additionally, the water supply monitoring system 130 includes a funnel 140 insertable within the reservoir 112, wherein the funnel 140 has a tubular section 142 configured to extend into the reservoir 112 and supply water through an outlet end 144, and a funnel section 146 located at an inlet end 148 to the tubular section 142 for supplying water to the reservoir 112 through the tubular section 142. As shown in FIG. 1, the outlet end 144 may be captured within reservoir 112 via retention mechanism 160.

Additionally yet, the water supply monitoring system 130 includes a water level monitoring system 150 physically coupled to the tree stand base 110 (see FIG. 2) that is configured to assess a first water level indicative of a low water level in the reservoir 112 and assess a second water level indicative of an optimal water level in the reservoir 112. According to one embodiment, the water level monitoring system 150 may include a dual float switch 152, including a first float 154 for assessing the low water level in the reservoir 112 and a second float 156 for assessing the optimal water level in the reservoir 112. The dual switch float 152 may be located within an elbow tube 158 formed with and through tree stand base 110 such that the interior of the elbow tube 158 is fluidically coupled with reservoir 112, as shown in FIG. 2. The elbow tube 158 may include a cap 155 with air holes 157 and a wiring connection 159 for dual float switch 152. As an example, the dual float switch 152 can include Model # LSIXB2-65-1/2-300, Part # LS-669 commercially available from distributors of float type level switches.

As shown in FIG. 3, the water supply monitoring system 130 further includes an indicating system 160 electrically coupled to the water level monitoring system 150 that is configured to provide a first indicator 162 when the first water level is achieved and a second indicator 164 when the second water level is achieved. The indicating system 160 can include a first light-emitting device as the first indicator 162 for indicating the first water level, and a second light-emitting device as the second indicator 164 for indicating the second water level, wherein the first light-emitting device and the second light-emitting device differ in color emission. For example, the first indicator 162 can include a red light, or red LED (light-emitting device), that indicates the low water level in the reservoir 112 has been achieved as measured by the first float 154. Additionally, for example, the second indicator 164 can include a green light, or green LED (light-emitting device), that indicates the optimal water level in the reservoir 112 has been achieved as measured by the second float 156. The first light-emitting device can illuminate only when the first water level is achieved and the second light-emitting device can illuminate only when the second water level is achieved.

The indicating system 160 is electrically coupled to the water level monitoring system 150 via an electrical signal chord 165 (or connecting wire(s)). The tree stand base 110 includes a signal output receptor 167 (or base outlet connector) mounted thereto that is electrically coupled to the water level monitoring system 150 and configured to provide an indicator signal to the indicating system 160. The electrical signal chord 165 includes a funnel plug connector 166 at a distal end thereof to plug into the signal output receptor 167 and relay the indicator signal to the indicating system 160.

As shown in FIG. 1, a power system 170 is coupled to the water level monitoring system 150 and the indicating system 160, and configured to provide power to the water level monitoring system and the indicating system. The power system can include a battery, such as a 9V battery, that is held within a battery compartment and replaceable via removal an access panel to the battery compartment.

According to one example, the tree stand 100 may be fabricated starting with an ordinary green plastic tree stand. A modification is made, inserting a 1½″ PVC elbow and pipe into the side of the base which houses a dual float switch. The dual float switch regulates the red and green lights, indicating the water level. The funnel tube is made by securing a funnel into a ½″ pex tube. Red and green LED lights are positioned at the top of the funnel and the wires running from the lights to the base of the tree stand are covered by heat shrink tubing. A 9 Volt battery is used to power the lights and is secured in a battery compartment on the side of the base. Finally, a coat of satin finish forest green paint can be applied to the entire tree stand to give it a uniform look.

In this example, the parts list for assembling the tree stand 100 includes: (a) HMS ULTIMATE CHRISTMAS TREE STAND FOR 8′ TREES (commercially available from Sears, Item # SPM3438721101, Model #009312561940); (b) FLOAT SWITCH (Model # LSIXB2-65-1/2-300, Part # LS-669); (c) 1½″ PVC ST 90° (commercially available from Home Depot, Model # C4807-2); (d) 1½″ PVC MALE ADAPTOR (commercially available from Home Depot, Model # C4804); (e) 4 POSITION MALE POLARIZED CONNECTOR (commercially available from Radio Shack, Model #274-224); (f) 4 POSITION FEMALE POLARIZED CONNECTOR (commercially available from Radio Shack, Model #274-234); (g) 9V BATTERY BOX (www.batteryspace.com, Product ID #2127, Part # SBH-9VAS); (h) 5′ WIRE (22 AWG); (i) ⅛″ HEAT SHRINK TUBING (commercially available from Gran Rapids Industrial Products, Grip #43108); (j) 1″ HEAT SHRINK TUBING (commercially available from Xscorion, # HST 1.03); (k) FUNNEL (commercially available from Harbor Freight, Item #00744); (l) ½″ PEX TUBING (commercially available from Home Depot, Model # QB3PS5X); (m) RED LED LIGHT (commercially available from Radio Shack, #276-0270); (n) GREEN LED LIGHT (commercially available from Radio Shack). Other materials can include glue, epoxy, bondo, paint, etc.

According to yet another example, after purchasing a live tree and giving it a fresh cut, the tree may be placed into the tree stand 100 and secured by the provided metal screws. Once the tree is located properly, the funnel tube can be inserted into the tree stand base 110. A 9V battery can be inserted into the battery compartment. Plug the wire from the funnel tube into the base. The red light should now be lit. Carefully fill the funnel with water. As you fill it, the red light will go out and no lights will be lit for a time. When the green light comes on, you can stop filling with water. The green light indicates that your water level is at its optimum. As the tree soaks up water, the green light will go out. Your water level is still good at this point. When the red light comes on, it is time to add more water, again only filling it until the green light comes on.

Although only certain embodiments of this invention have been described in detail above, those skilled in the art will readily appreciate that many modifications are possible in the embodiments without materially departing from the novel teachings and advantages of this invention. Accordingly, all such modifications are intended to be included within the scope of this invention.

1. A tree stand, comprising:
a tree stand base having a reservoir configured to receive a trunk of a tree and contain water for nourishing said tree, said tree stand base further including means for securing said trunk of said tree within said reservoir; and
a water supply monitoring system configured to assess a level of said water in said reservoir, said water supply monitoring system comprising:
a funnel insertable within said reservoir, said funnel comprising a tubular section configured to extend into said reservoir and supply water through an outlet end, and a funnel section located at an inlet end to said tubular section for supplying water to said reservoir through said tubular section,
a water level monitoring system physically coupled to said tree stand base that is configured to assess a first water level indicative of a low water level in said reservoir and assess a second water level indicative of an optimal water level in said reservoir,
an indicating system electrically coupled to said water level monitoring system that is configured to provide a first indicator when said first water level is achieved and a second indicator when said second water level is achieved, and
a power system coupled to said water level monitoring system and said indicating system, and configured to provide power to said water level monitoring system and said indicating system.

2. The tree stand of claim 1, wherein said water level monitoring system comprises a dual float switch, said dual float switch including a first float to indicate said first water level and a second float to indicate said second water level.

3. The tree stand of claim 1, wherein said indicating system is mounted proximate said inlet end to said funnel.

4. The tree stand of claim 1, wherein said indicating system comprises a first light-emitting device for indicating said first water level, and a second light-emitting device for indicating said second water level.

5. The tree stand of claim 4, wherein said first light-emitting device and said second light-emitting device differ in color emission.

6. The tree stand of claim 4, wherein said first light-emitting device illuminates only when said first water level is achieved and said second light-emitting device illuminates only when said second water level is achieved.

7. The tree stand of claim 1, wherein said tree stand base includes a signal output receptor mounted thereto that is electrically coupled to said water level monitoring system and configured to provide an indicator signal to said indicating system.

8. The tree stand of claim 7, wherein said indicating system includes an electrical signal chord configured to plug into said signal output receptor and relay said indicator signal to said indicating system.

9. The tree stand of claim 1, wherein said power system comprises a battery.

10. A monitoring system for a tree stand, comprising:
a water supply monitoring system configured to be coupled to a tree stand base having a reservoir that receives a trunk of a tree and contains water for nourishing said tree, said water supply monitoring system further configured to asses a level of said water in said reservoir, wherein said water supply monitoring system comprises:
a funnel insertable within said reservoir, said funnel comprising a tubular section configured to extend into said reservoir and supply water through an outlet end, and a funnel section located at an inlet end to said tubular section for supplying water to said reservoir through said tubular section,
a water level monitoring system configured to be physically coupled to said tree stand base that assesses a first water level indicative of a low water level in said reservoir and assesses a second water level indicative of an optimal water level in said reservoir,
an indicating system electrically coupled to said water level monitoring system that is configured to provide a first indicator when said first water level is achieved and a second indicator when said second water level is achieved, and
a power system coupled to said water level monitoring system and said indicating system, and configured to provide power to said water level monitoring system and said indicating system.

11. The monitoring system of claim 10, wherein said water level monitoring system comprises a dual float switch, said dual float switch including a first float to indicate said first water level and a second float to indicate said second water level.

12. The monitoring system of claim 10, wherein said indicating system is mounted proximate said inlet end to said funnel.

13. The monitoring system of claim 10, wherein said indicating system comprises a first light-emitting device for indicating said first water level, and a second light-emitting device for indicating said second water level.

14. The monitoring system of claim 13, wherein said first light-emitting device and said second light-emitting device differ in color emission.

15. The monitoring system of claim 13, wherein said first light-emitting device illuminates only when said first water level is achieved and said second light-emitting device illuminates only when said second water level is achieved.

16. The monitoring system of claim 1, wherein said tree stand base includes a signal output receptor mounted thereto that is electrically coupled to said water level monitoring system and configure to provide an indicator signal to said indicating system.

17. The monitoring system of claim 16, wherein said indicating system includes an electrical signal chord configured to plug into said signal output receptor and relay said indicator signal to said indicating signal.

18. The monitoring system of claim 10, wherein said power system comprises a battery.
